(19) United States
(12) Patent Application Publication
(10) Pub. No.: US 2003/0182458 A1
(43) Pub. Date: Sep. 25, 2003

(54) Generating a decoupled presentation layer in an application

(76) Inventors: Syed M. Ali, Sunnyvale, CA (US); Robert N. Goldberg, Emerald Hills, CA (US); Bruce K. Daniels, Capitola, CA (US); Yury Kamen, Foster City, CA (US)

Correspondence Address: ROSENTHAL & OSHA L.L.P. / SUN, 1221 MCKINNEY, SUITE 2800, HOUSTON, TX, 77010, US

(21) Appl. No.: 10/104,105

(22) Filed: Mar. 22, 2002

(51) Int. Cl. G06F 15/163; G06F 9/00

(52) U.S. Cl. 709/310; 709/328

(57) ABSTRACT

A method for generating an application, including obtaining a business object specification defining a characteristic of a business object, obtaining an application usage specification defining how the business object is to be used in the application, and generating the application using the business object specification and the application usage specification, wherein the application comprises a presentation layer and a logic layer.

### BACKGROUND OF THE INVENTION

An application typically includes two layers: a logic layer and a presentation layer. The logic layer includes business and process logic for the application. The presentation layer includes look-and-feel customizations of the application, i.e., a graphical user interface. Conventional application development typically combines the two layers during the development phase to produce an integrated application.

With the increasing complexity of applications, separation of the presentation layer and the logic layer is desirable. The separation of the presentation layer and the logic layer allows changes to be made to one layer without affecting the other layer. This allows code to be readily scalable and easily maintainable.

One typical method of separating the application logic and the presentation logic is to use a design pattern. The design pattern describes a proven solution, from experienced hands, for a recurring design problem. See Vijay Ramachandran, Design Patterns for Building Flexible and Maintainable J2EE ™ Applications, January 2002, http://developer.java.sun/developer/technical ArticlesJ2EE/despat/. The use of such patterns makes the design of an application transparent. A specific design pattern that may be used to decouple the presentation layer from the logic layer is a front controller. The front controller channels all client requests through a single object, which decides on the next view to be displayed to the client.

The following example illustrates how the front controller may be used in the context of a web application. Consider a web application where the view displayed to the client depends on what the client is doing. The views are highly interactive, i.e., prompting the client for information, and highly interdependent. In the absence of the front controller, the web application will be a collection of interdependent web pages. This makes the web application difficult to maintain. For example, if the application was modified to accommodate more web pages, it will require a significant amount of work to properly integrate the new pages.

The front controller solves this problem by centralizing the decision on the next view. Using the front controller, only a small area of the web application requires modification, i.e., updating the front controller, with the changes being reflected across the entire application. Thus, changes made to the business layer or the presentation layer may be done independently of each other.

Another method to separate the application logic and the presentation logic is to use Enhydra XMLC. Enhydra XMLC is an Extensible Mark-up Language (XML) compiler that converts web page templates, including Hypertext Mark-up Language (HTML), Wireless Mark-up Language (WML), etc., into resources that can be directly accessed from a Java™ program using standard Document Object Model (DOM) manipulation syntax. ID and class attributes are added to the web page templates as dynamic tags to allow the business layer to manipulate the dynamic content of the web page. See About Enhydra XMLC, www.xmlc.enhydra.org/project/aboutProject/index.html.

The following example illustrates how the Enhydra XMLC may be used in the context of a web application. Consider a web application where the view displayed to the client depends on what the client is doing. The views are highly interactive, i.e., prompting the client for information, and highly interdependent. If a layout change to a number of the web pages is required, using Enhydra XMLC, the graphic designer need only redesign the pager using an HTML (or equivalent editor) and insert dynamic tags containing ID and class information. These pages may subsequently be compiled using Enhydra XMLC and deployed without requiring any modification to the underlying business layer.

### SUMMARY OF INVENTION

In general, in one aspect, the invention relates to a method for generating an application, comprising obtaining a business object specification defining a characteristic of a business object, obtaining an application usage specification defining how the business object is to be used in the application, and generating the application using the business object specification and the application usage specification, wherein the application comprises a presentation layer and a logic layer.

In general, in one aspect, the invention relates to a method for generating an application, comprising obtaining a business object specification defining a characteristic of a business object, obtaining an application usage specification defining how the business object is to be used in the application, generating the application using the business object specification and the application usage specification, wherein the application comprises a presentation layer and a logic layer, modifying the presentation layer creating a customization file, modifying the application usage specification creating a modified application usage specification, modifying the business object specification creating a modified business object specification, and re-generating the application using the customization file, the modified application usage specification, and the modified business object specification.

In general, in one aspect, the invention relates to a method for generating a presentation layer comprising obtaining an application usage specification and a business object specification, parsing the application usage specification and the business object specification to obtain a state and a transition, generating a view and a supporting code for the state, populating the view using a variable type obtained from the business object specification, and a variable interaction qualifier obtained from the application usage specification, wherein the variable type and variable interaction qualifier correspond to a variable, and generating a transition widget and supporting platform specific code to trigger the transition from the view.

In general, in one aspect, the invention relates to a method for generating a presentation layer comprising obtaining an application usage specification and a business object specification, parsing the application usage specification and the business object specification to obtain a state and a transition, generating a view and a supporting code for the state, populating the view using a variable type obtained from the business object specification, and a variable interaction qualifier obtained from the application usage specification, wherein the variable type and variable interaction qualifier correspond to a variable, generating a transition widget and supporting platform specific code to trigger the transition from the view, generating a properties file used for deploying the presentation layer, and generating code for an embedded state within the state.

In general, in one aspect, the invention relates to a computer-readable medium having recorded thereon instructions executable by a processor, the instructions for obtaining a business object specification defining a characteristic of a business object, obtaining an application usage specification defining how the business object is to be used in the application, and generating the application using the business object specification and the application usage specification, wherein the application comprises a presentation layer and a logic layer.

In general, in one aspect, the invention relates to a computer-readable medium having recorded thereon instructions executable by a processor, the instructions for obtaining an application usage specification and a business object specification, parsing the application usage specification and the business object specification to obtain a state and a transition, generating a view and a supporting code for the state, populating the view using a variable type obtained from the business object specification, and a variable interaction qualifier obtained from the application usage specification, wherein the variable type and variable interaction qualifier correspond to a variable, and generating a transition widget and supporting platform specific code to trigger the transition from the view.

In general, in one aspect, the invention relates to an apparatus for generating an application, comprising means for obtaining a business object specification defining a characteristic of a business object, means for obtaining an application usage specification defining how the business object is to be used in the application, and means for generating the application using the business object specification and the application usage specification, wherein the application comprises a presentation layer and a logic layer.

In general, in one aspect, the invention relates to an apparatus for generating an application, comprising means for obtaining a business object specification defining a characteristic of a business object, means for obtaining an application usage specification defining how the business object is to be used in the application, means for generating the application using the business object specification and the application usage specification, wherein the application comprises a presentation layer and a logic layer, means for modifying the presentation layer creating a customization file, means for modifying the application usage specification creating a modified application usage specification, means for modifying the business object specification creating a modified business object specification, and means for re-generating the application using the customization file, the modified application usage specification, and the modified business object specification.

In general, in one aspect, the invention relates to an apparatus for generating a presentation layer comprising means for obtaining an application usage specification and a business object specification, means for parsing the application usage specification and the business object specification to obtain a state and a transition, means for generating a view and a supporting code for the state, means for populating the view using a variable type obtained from the business object specification, and a variable interaction qualifier obtained from the application usage specification, wherein the variable type and variable interaction qualifier correspond to a variable, and means for generating a transition widget and supporting platform specific code to trigger the transition from the view.

In general, in one aspect, the invention relates to an apparatus for generating a presentation layer comprising means for obtaining an application usage specification and a business object specification, means for parsing the application usage specification and the business object specification to obtain a state and a transition, means for generating a view and a supporting code for the state, means for populating the view using a variable type obtained from the business object specification, and a variable interaction qualifier obtained from the application usage specification, wherein the variable type and variable interaction qualifier correspond to a variable, means for generating a transition widget and supporting platform specific code to trigger the transition from the view, means for generating a properties file used for deploying the presentation layer, and means for generating code for an embedded state within the state.

Other aspects and advantages of the invention will be apparent from the following description and the appended claims.

### BRIEF DESCRIPTION OF THE DRAWINGS

FIG. 1 illustrates a typical computer system.

FIG. 2 illustrates a flow diagram for generating an application in accordance with one embodiment of the invention.

FIG. 3 illustrates a flowchart generating a presentation layer in accordance with one embodiment of the invention.

FIG. 4 illustrates an exemplary portion of a presentation layer generated in accordance with one embodiment of the invention.

### DETAILED DESCRIPTION

Exemplary embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The invention relates to a method for generating an application having a presentation layer decoupled from a logic layer. Further, the invention relates to using a business object specification and an application usage specification to develop and generate the application having the presentation layer decoupled from the logic layer. Further, the invention relates to re-generating the application having the presentation layer decoupled from the logic layer using a marked modification file.

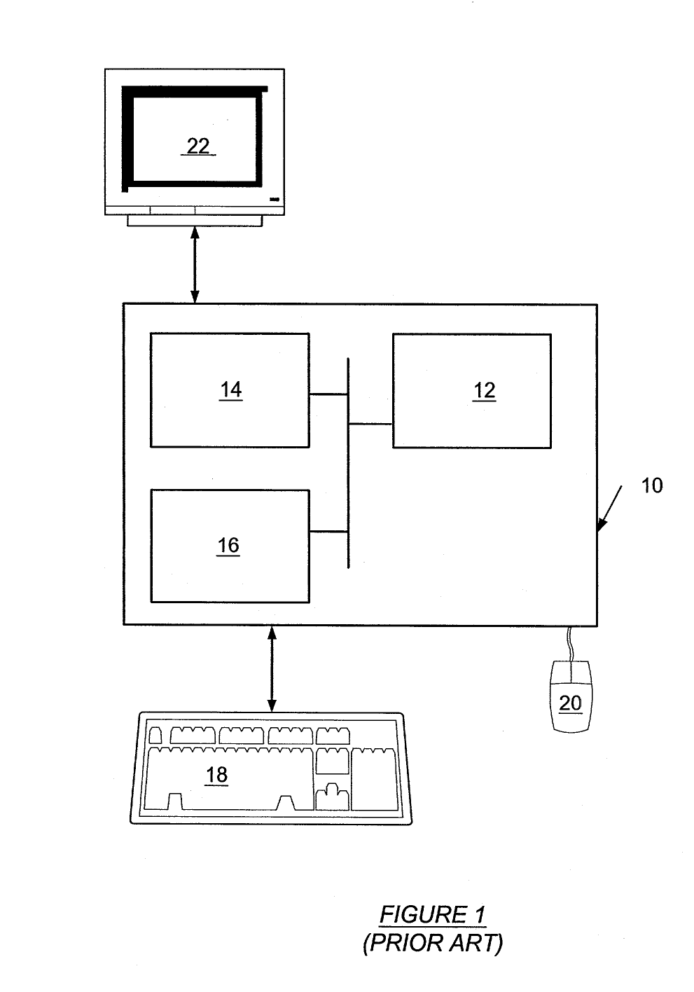

The present invention may be implemented on virtually any type computer regardless of the platform being used. For example, as shown in FIG. 1, a typical computer (10) includes a processor (12), associated memory (14), a storage device (16), and numerous other elements and functionalities typical of today's computers (not shown). The computer (10) may also include input means, such as a keyboard (18) and a mouse (20), and output means, such as a monitor (22). Those skilled in the art will appreciate that these input and output means may take other forms in an accessible environment.

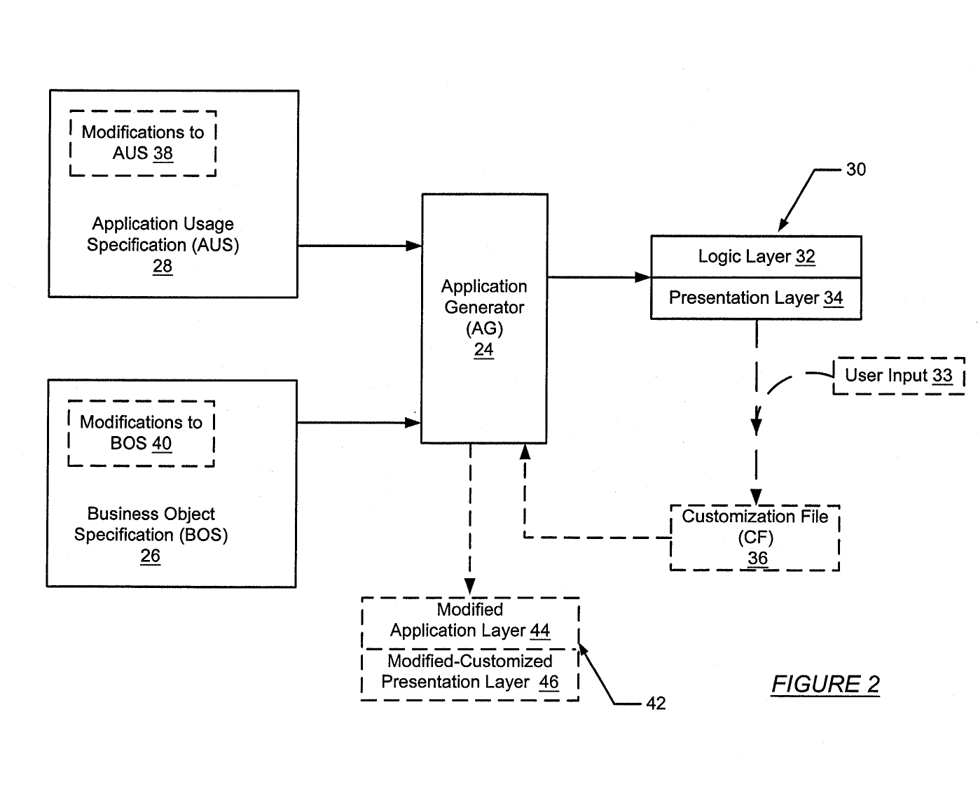

FIG. 2 illustrates a flow diagram for generating an application in accordance with one embodiment of the invention. The application generator (AG) (24) takes a business object specification (BOS) (26) and an application usage specification (AUS) (28) as inputs and generates an application (30) having a logic layer (32) and a presentation layer (34).

The BOS (26) defines the characteristics of all business objects to be used in the application (30). These characteristics may include, but are not limited to, attributes, attribute constraints, persistence information, triggers, relationships, etc. For example, the BOS (26) may define a trigger for a particular business object such that when a specific event occurs, such as an update to a data field in a database, a set of Structured Query Language (SQL) statements is “fired-off” to perform an integrity check on the database. Further, the BOS (26) defines the relationships between the various business objects.

The following code illustrates an exemplary business object, in accordance with the embodiment described above.

Code Sample 1: Business Object

| | |
|---|---|
| 1 | persistent class Employee { |

| | |
|---|---|
| 2 | properties UUID = ″ID_78F8AF10A2CF11D3BA020080C74455C6″; |
| 3 | persistent String firstNarne; |
| 4 | persistent String lastName; |
| 5 | persistent String extension; |
| 6 | persistent Date hireDate; |
| 7 | persistent Date dob; |
| 8 | persistent String empNo; |
| 9 | references (0, 1, 0, n) Department department employees; |
| 10 | references (0, 1, 0, n) Building worksInBuilding employees; |
| 11 | references (0, 1, 0, n) Employee manager reports; |
| 12 | references (0, n, 0, n) Project projects employees; |
| 13 | PRIMARY KEY (empNo); |
| 14 | |
| 15 | # = ″Define a way to assign a new Primary Key″ |
| 16 | method assignMextPK( ) returns EmployeePK { |

| | |
|---|---|
| 17 | synchronized (this.getClass( )) { |

| | |
|---|---|
| 18 | EmployeeFactory f = (EmployeeFactory |
| 19 | ) Global.factoryManager( ) .getFactory(Employee.class); |

| 20 | EmployeePK pk = null; | |
|---|---|---|
| 21 | java.util.Random r = new java.util.Random( ))); | |
| 22 | try | { |

| | | |
|---|---|---|
| 23 | do | { |

| | |
|---|---|
| 24 | int i = r.nextInt( ); |
| 25 | pk = f.newprimaryKey(″empNo″ + (new Integer(i) .tostring ( ))); |

| | |
|---|---|
| 26 | } while (f.findByPrimaryKeyIfAny(pk) != null); |

| | |
|---|---|
| 27 | } catch (javax.ejb.FinderException fe) { |

| | |
|---|---|
| 28 | throw new RuntimeException(fe.toString ( )); |

| | |
|---|---|
| 29 | } |
| 30 | return pk; |

| | |
|---|---|
| 31 | } |

| | |
|---|---|
| 32 | } |

| | |
|---|---|
| 33 | } // class Employee |

In the code sample listed above referred to as “Code Sample 1”, lines 3-8 define the variables and corresponding types to be used in the business object. For example, the variable “firstName” defined on line 3 is defined as a persistent variable of string type. Lines 9-12 define the relationship that this particular business object has with other objects in the business object specification. Lines 15-31 define the assignNextPK() method within the business object.

The AUS (28) defines how the business objects, as defined by the BOS (26), are to be used within the application. In one or more embodiments of the invention, the AUS (28) is defined as a series of states and transitions. The states correspond to points in the application where interaction is required. The interaction may include, but is not limited to, interaction from a user, interaction from another enterprise application, etc. For example, in a web-based application, a user may be presented with a screen that requires them to enter a number corresponding to the number of items they wish to purchase and then click the “proceed” button. In this case, that particular web page would represent the state. The transitions correspond to business logic of the enterprise application. Continuing with the web page example above, when the user clicks the “proceed” button, the transition is initiated. In this particular case, the transition may include code to determine the total price of the products being ordered using the number of items the user previously entered.

The transitions are used to link the various states together forming an overall business process. Further, a particular enterprise application may be defined such that numerous transitions may be used to exit a particular state. For example, in a web-based application, a particular screen may have a “proceed” button and an “exit” button, where each button triggers a different set of business logic. Further, numerous transitions may also be used to enter a particular state. For example, a “proceed” button on one page and a “cancel” button on another page could both result in bringing the user back to an enterprise application's homepage.

Additionally, the AUS (28) contains variable interaction qualifiers. The interaction qualifiers define constraints on variable usage and display within the application. For example, some variables within the application will be designated as HTML text which may not be modified, while other variables may be designated as containing text that may be modified.

The following code illustrates an exemplary portion of an application usage specification corresponding to one state in the application, in accordance with the embodiment described above.

Code Sample 2: Portion of an Application Usage Specification

| | |
|---|---|
| 1 | state EmployeeDetail( Employee e) ″Employee Detail″ |
| 2 | { |

| | | |
|---|---|---|
| 3 | e ″Employee Information″: | RW { |

| | | |
|---|---|---|
| 4 | empNo ″Employee Number″: | R, |
| 5 | lastName ″Last Name″, | |
| 6 | extension ″Extension″, | |
| 7 | hireDate ″Hire Date″, | |

| | | |
|---|---|---|
| 8 | manager ″Manager″: | R { |

| | |
|---|---|
| 9 | empNo ″Manager Employee No″, |
| 10 | lastName ″Manager Last Name″ |

| | |
|---|---|
| 11 | } |

| | |
|---|---|
| 12 | } |

| | |
|---|---|
| 13 | transition UpdateEmployee ″Update Employee″ { |

| | |
|---|---|
| 14 | return new EmployeeDetail (e); |
| 15 | |

| | |
|---|---|
| 16 | } // transition UpdateEmployee |

| | |
|---|---|
| 17 | } // state EmployeeDetail |

In the code sample listed above referred to as “Code Sample 2”, lines 1-17 define the EmployeeDetail state, and lines 13-16 define the UpdateEmployee transition within the state. Additionally, each variable listed within the aforementioned states has an interaction qualifier. For example, empNo on line 4 has an interaction qualifier denoted as “R”, that represents, in this example, that the empNo variable is constrained as a read-only variable. Those skilled in the art will appreciate that an interaction qualifier may be specified in many different ways, and that a particular interaction qualifier may represent different constraints in different implementations.

Referring back to FIG. 2, the AG (24) uses the AUS (28) and the BOS (26) to generate the application (30). The logic layer (32) is generated using a method disclosed in a U.S. Provisional Application Serial No. 60/354,771 filed Feb. 6, 2002, entitled “Development and Generation of Enterprise Application using a High-level Specification”, in the names of Bruce K. Daniels, Robert N. Goldberg, Yury Kamen, and Syed M. Ali. The presentation layer (34) is generated by the AG (24) using default presentation widgets. The process for generating the presentation layer (34) will be described in detail below. Once the application (30) has been generated, the presentation layer (34) may be modified to enhance the look-and-feel aspects of the application (30). All modifications that are made to the presentation layer (34), with respect to the initial presentation layer (34) generated by the AG (24), are marked and stored in a Customization File (CF) (36). This allows modifications to the presentation layer (34) to be preserved, and the logic layer (32) to be modified. In one embodiment of the invention, the presentation layer (34) is customized via user input (33) to produce the customization file (36).

For example, consider a situation where a first version of an application was generated. Subsequently, the presentation layer was substantially modified. After a year has passed, an upgrade to the application is required, thus the AUS and BOS are modified and a second version of the application is generated. If the changes were not marked, then the presentation layer would have to be re-modified to make the application look and feel like the first version. In one embodiment of the invention, a three-way merge is performed such that the changes made to the first version are not lost in subsequent versions. The three-way merge procedure takes the initial presentation layer generated for the first version of the application, the presentation layer modification file, and the presentation layer generated for the second version of the application to produce a new presentation layer. The new presentation layer contains all the modifications made to produce the modified presentation layer of the first version, plus any new graphics that were a result of the modified AUS and/or BOS.

Referring to FIG. 2, when modifications to the AUS (38) and/or modifications to the BOS (40) occur, the application may be regenerated, as described above, to produce a modified application (42). The modified application contains a modified logic layer (44), and a modified-customized presentation layer (46). The modified-customized presentation layer (46) is generated using the three-way merge procedure described above. The three-way merge procedure uses a CF (36) in generating the modified-customized presentation layer (46).

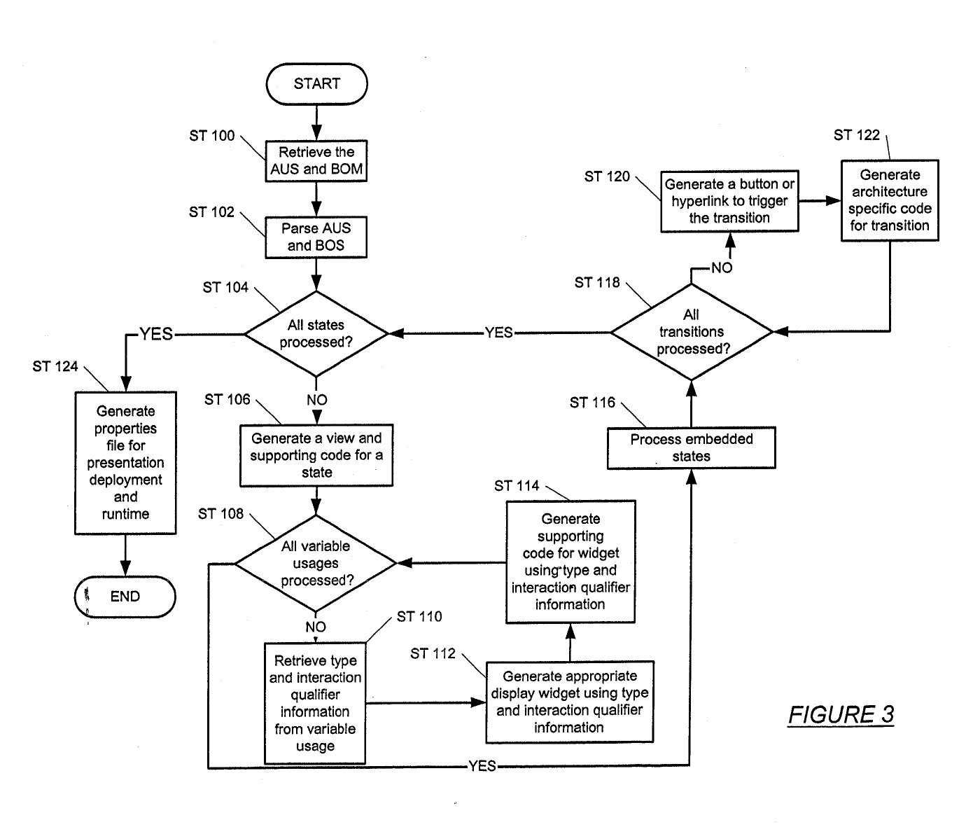

FIG. 3 illustrates a flowchart generating a presentation layer in accordance with one embodiment of the invention. An AUS and a BOS are initially received by the application generator (Step 100). The AUS and BOS are then parsed to obtain states and transitions (Step 102). Each state found during the step 102 is subsequently processed in steps 106-122. For each state, a view (e.g., a web page, a particular screen within an application, etc.) is generated along with the supporting code (Step 106). If all variable usages in the state have not been processed (Step 108), then the variable type and interaction qualifier information for the each variable usage (Step 110) is retrieved. Using the retrieved variable type and interaction qualifier information, an appropriate display widget (Step 112) and supporting code (Step 114) is generated.

The variable type corresponds to a classification of data that provides information as to how the variable is to be used within the application. For example, in one embodiment of the invention, the variable may be assigned one of three types: shared, session, or local. Those skilled in the art will appreciate that the invention is not limited to the variable types list above.

In one embodiment of the invention, the variable type is obtained from the business object specification. In another embodiment of the invention, the variable type is declared within the application usage specification.

In one embodiment of the invention, there are two distinct interaction qualifiers denoted as R and RW. Each interaction qualifier is mapped to a display widget. For example, some variables may be designated as read-only and display an HTML text. For example, a variable usage with an interaction qualifier R is mapped to HTML text, and a variable usage with an interaction qualifier RW is mapped to an Input Field. Those skilled in the art will appreciate that the interaction qualifiers listed above are only examples, and are not to be interpreted as the only potential interaction qualifiers.

Once all the variables usages have been processed (Step 108), then each embedded state within the state is processed (Step 116). The embedded state corresponds to a state residing in a state. For example, in a web page, a state may correspond to the entire web page and the embedded state may correspond to a frame within the web page.

In some cases, steps 108 through 114 are repeated recursively to process variable usages. For example, consider a state that lists a collection of purchase order objects, where each purchase order object contains a collection of line item objects. In this case, for each purchase order object, the application generator must retrieve variable usages for each purchase order object which implies obtaining all variable usages corresponding to all the line item objects within the purchase order object.

After all the embedded states have been processed (Step 116), then each transaction with the state must be processed (Step 118). For each transition in the state, a button or hyperlink is generated to trigger the transition (Step 120). Additionally, architecture specific code is generated for the transition (Step 122). Once steps 106 to 122, as described above, have been completed for each state in the AUS and BOS (Step 104), then the application generator generates a properties file for presentation deployment and runtime (Step 124).

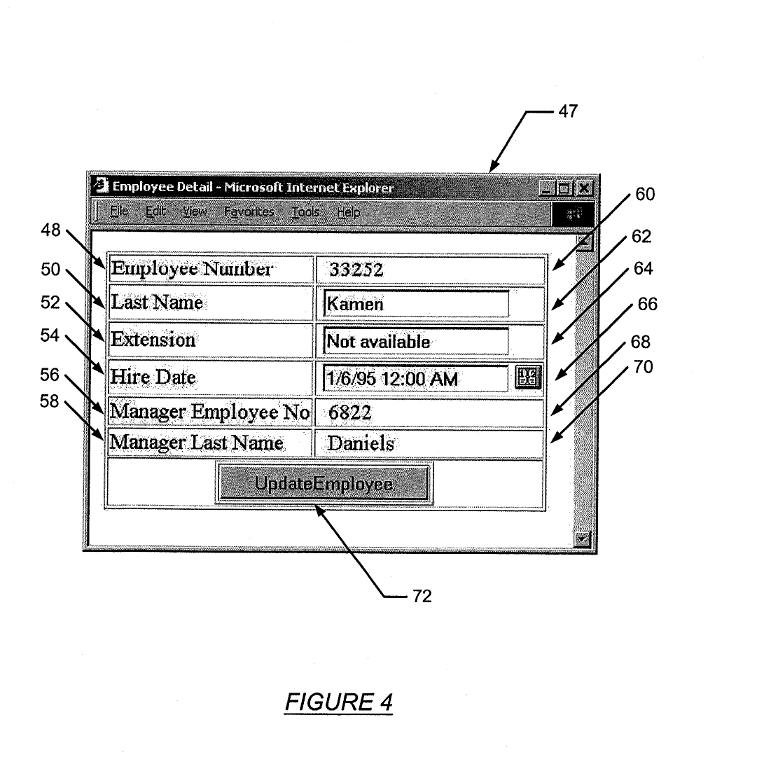

FIG. 4 illustrates an exemplary portion of a presentation layer generated in accordance with one embodiment of the invention. The portion of the presentation layer illustrated in FIG. 4 corresponds to a screen (47) output by the AG using the steps outlined in FIG. 3 and the portion of an AUS defined in Code Sample 2 described above. Specifically, the Employee Number (48), Manager Employee No. (56), and Manager Last Name (58) each have scope R (see Code Sample 2) and are shown on the screen (47) as HTML text (60, 68, and 70). In contrast, Last Name (50), Extension (52), and Hire Date (54) each have scope RW and are shown on the screen (47) as Input Fields (62, 64, and 66). In addition, the portion of the AUS in Code Sample 2 contains one transition: UpdateEmployee. This transition is shown on the screen as a button (72).

Embodiments of the invention may include one or more of the following advantages. The invention allows for rapid generation of a prototype by generating a presentation layer from the AUS and BOS. Further, the invention customizations made to the presentation layer persist through modifications to the logic layer. Further, the invention allows for generation of easily scalable and maintainable code. Further, the invention allows the generated presentation layer to be easily modified by a non-programmer. Further, the invention provides a GUI designer with a full working GUI that may be used as a framework to start presentation layer customization.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for generating an application, comprising:
obtaining a business object specification defining a characteristic of a business object;
obtaining an application usage specification defining how the business object is to be used in the application; and
generating the application using the business object specification and the application usage specification, wherein the application comprises a presentation layer and a logic layer.

2. The method of claim 1, further comprising:
modifying the presentation layer creating a customization file;
modifying the application usage specification creating a modified application usage specification;
modifying the business object specification creating a modified business object specification; and
re-generating the application using the customization file, the modified application usage specification, and the modified business object specification.

3. The method of claim 1, the presentation logic layer comprising a graphical user interface.

4. The method of claim 1, the logic layer comprising business logic.

5. The method of claim 1, the application usage specification comprising a variable interaction constraint.

6. The method of claim 5, wherein the interaction constraint is used to map a variable to a presentation widget type.

7. The method of claim 6, wherein the presentation widget type is a hypertext mark-up language input field.

8. The method of claim 1, the business object specification comprising a variable type.

9. The method of claim 8, wherein the variable type is used to map a variable to a presentation widget type.

10. The method of claim 2, the re-generating the application comprising a three-way merge.

11. The method of claim 1, the business object specification comprising a relationship for the business object.

12. The method of claim 1, the business object specification comprising a constraint for the business object.

13. The method of claim 1, the business object specification comprising a trigger for the business object.

14. The method of claim 1, the business object specification comprising a business object method.

15. The method of claim 1, the application usage specification comprising a state and a transition.

16. The method of claim 1, wherein the application usage specification defines an interaction variable.

17. The method of claim 1, wherein the generating of the application uses an application generator.

18. A method for generating an application, comprising:
obtaining a business object specification defining a characteristic of a business object;
obtaining an application usage specification defining how the business object is to be used in the application;
generating the application using the business object specification and the application usage specification, wherein the application comprises a presentation layer and a logic layer;
modifying the presentation layer creating a customization file;
modifying the application usage specification creating a modified application usage specification;
modifying the business object specification creating a modified business object specification; and
re-generating the application using the customization file, the modified application usage specification, and the modified business object specification.

19. A method for generating a presentation layer comprising:
obtaining an application usage specification and a business object specification;
parsing the application usage specification and the business object specification to obtain a state and a transition;
generating a view and a supporting code for the state;
populating the view using a variable type obtained from the business object specification, and a variable interaction qualifier obtained from the application usage specification, wherein the variable type and variable interaction qualifier correspond to a variable; and
generating a transition widget and supporting platform specific code to trigger the transition from the view.

20. The method of claim 19, further comprising:
generating a properties file used for deploying the presentation layer.

21. The method of claim 19, further comprising:
generating code for an embedded state within the state.

22. The method of claim 19, the populating of the view comprising using the variable interaction qualifier and the variable type to map the variable to a presentation widget.

23. The method of claim 22, wherein the presentation widget is hypertext mark-up language text.

24. The method of claim 19, wherein the transition widget corresponds to a hyperlink.

25. The method of claim 19, wherein the transition widget corresponds to a button.

26. The method of claim 19, wherein the state defines an interaction with a client.

27. The method of claim 19, the transition comprising business logic of the application.

28. The method of claim 19, wherein the view corresponds to a webpage.

29. A method for generating a presentation layer comprising:
obtaining an application usage specification and a business object specification;
parsing the application usage specification and the business object specification to obtain a state and a transition;
generating a view and a supporting code for the state;
populating the view using a variable type obtained from the business object specification, and a variable interaction qualifier obtained from the application usage specification, wherein the variable type and variable interaction qualifier correspond to a variable;
generating a transition widget and supporting platform specific code to trigger the transition from the view;
generating a properties file used for deploying the presentation layer; and
generating code for an embedded state within the state.

30. A computer-readable medium having recorded thereon instructions executable by a processor, the instructions for:
obtaining a business object specification defining a characteristic of a business object;
obtaining an application usage specification defining how the business object is to be used in the application; and
generating the application using the business object specification and the application usage specification, wherein the application comprises a presentation layer and a logic layer.

31. The computer readable medium of claim 30, further comprising:
modifying the presentation layer creating a customization file;
modifying the application usage specification creating a modified application usage specification;
modifying the business object specification creating a modified business object specification; and
re-generating the application using the customization file, the modified application usage specification, and the modified business object specification.

32. The computer readable medium of claim 30, the presentation logic layer comprising a graphical user interface.

33. The computer readable medium of claim 30, the logic layer comprising business logic.

34. The computer readable medium of claim 30, the application usage specification comprising a variable interaction constraint.

35. The computer readable medium of claim 34, wherein the interaction constraint is used to map a variable to a presentation widget type.

36. The computer readable medium of claim 35, wherein the presentation widget type is a hypertext mark-up language input field.

37. The computer readable medium of claim 30, the business object specification comprising a variable type.

38. The computer readable medium of claim 37, wherein the variable type is used to map a variable to a presentation widget type.

39. The computer readable medium of claim 31, the re-generating of the application comprising a three-way merge.

40. A computer-readable medium having recorded thereon instructions executable by a processor, the instructions for:
obtaining an application usage specification and a business object specification;
parsing the application usage specification and the business object specification to obtain a state and a transition;
generating a view and a supporting code for the state;
populating the view using a variable type obtained from the business object specification, and a variable interaction qualifier obtained from the application usage specification, wherein the variable type and variable interaction qualifier correspond to a variable; and
generating a transition widget and supporting platform specific code to trigger the transition from the view.

41. The computer readable medium of claim 40, further comprising:
generating a properties file used for deploying the presentation layer.

42. The computer readable medium of claim 40, further comprising:
generating code for an embedded state within the state.

43. The computer readable medium of claim 40, the populating of the view comprising using the variable interaction qualifier and the variable type to map the variable to a presentation widget.

44. The computer readable medium of claim 43, wherein the presentation widget is hypertext mark-up language text.

45. The computer readable medium of claim 40, wherein the transition widget corresponds to a hyperlink.

46. The computer readable medium of claim 40, wherein the transition widget corresponds to a button.

47. The computer readable medium of claim 40, wherein the state defines an interaction with a client.

48. The computer readable medium of claim 40, the transition comprising business logic of the application.

49. An apparatus for generating an application, comprising:
means for obtaining a business object specification defining a characteristic of a business object;
means for obtaining an application usage specification defining how the business object is to be used in the application; and
means for generating the application using the business object specification and the application usage specification, wherein the application comprises a presentation layer and a logic layer.

50. An apparatus for generating an application, comprising:
means for obtaining a business object specification defining a characteristic of a business object;
means for obtaining an application usage specification defining how the business object is to be used in the application;
means for generating the application using the business object specification and the application usage specification, wherein the application comprises a presentation layer and a logic layer;
means for modifying the presentation layer creating a customization file;
means for modifying the application usage specification creating a modified application usage specification;
means for modifying the business object specification creating a modified business object specification; and
means for re-generating the application using the customization file, the modified application usage specification, and the modified business object specification.

51. An apparatus for generating a presentation layer comprising:
means for obtaining an application usage specification and a business object specification;
means for parsing the application usage specification and the business object specification to obtain a state and a transition;
means for generating a view and a supporting code for the state;
means for populating the view using a variable type obtained from the business object specification, and a variable interaction qualifier obtained from the application usage specification, wherein the variable type and variable interaction qualifier correspond to a variable; and
means for generating a transition widget and supporting platform specific code to trigger the transition from the view.

52. An apparatus for generating a presentation layer comprising:
means for obtaining an application usage specification and a business object specification;
means for parsing the application usage specification and the business object specification to obtain a state and a transition;
means for generating a view and a supporting code for the state;
means for populating the view using a variable type obtained from the business object specification, and a variable interaction qualifier obtained from the application usage specification, wherein the variable type and variable interaction qualifier correspond to a variable;
means for generating a transition widget and supporting platform specific code to trigger the transition from the view;
means for generating a properties file used for deploying the presentation layer; and
means for generating code for an embedded state within the state.
